(19) United States
(12) Patent Application Publication
(10) Pub. No.: US 2008/0201872 A1
(43) Pub. Date: Aug. 28, 2008

(54) Aqueous Formulations Of Dye Mixtures

(76) Inventor: Adolf Kaser, Bottmingen (CH)

Correspondence Address: JoAnn Villamizar;Ciba Corporation/Patent Department, 540 White Plains Road, P.O. Box 2005, Tarrytown, NY, 10591, US

(21) Appl. No.: 11/791,590

(22) PCT Filed: Nov. 28, 2005
(86) PCT No.: PCT/EP05/56255

§ 371 Date: May 24, 2007

(30) Foreign Application Priority Data
Dec. 6, 2004 (EP) 04106313.2

(51) Int. Cl. C09B 23/00

(52) U.S. Cl. 8/658

(57) ABSTRACT

The present invention relates to an aqueous formulation of dye mixtures, comprising at least one anionic dye, at least one cationic dye and/or an acid dye derived from a cationic structural unit and, optionally, at least one formulation assistant, a process for their preparation and the use thereof for dyeing natural or synthetic fibres, especially paper or paperboard.

The present invention relates to an aqueous formulation of dye mixtures, comprising at least one anionic dye, at least one cationic dye and/or an acid dye derived from a cationic structural unit and, optionally, at least one formulation assistant, a process for their preparation and the use thereof for dyeing natural or synthetic fibres, especially paper or paperboard.

Both anionic and cationic direct dyes have previously found widespread use for the dyeing of paper. However, whilst anionic direct dyes, in general, are characterized by a high affinity, particularly to bleached pulp, relatively high light stability, but only medium colouristic strength and brilliance, cationic dyes, as defined in the instant invention, generally exhibit high colouristic strength and brilliance, but only medium affinity for bleached pulp combined with poor light stability.

Consequently, it would clearly be advantageous to combine the desirable properties of both types of dye in order to produce a dye system capable of dyeing paper in brilliant colour tones with a high degree of exhaustion to yield dyeings possessing excellent fastness properties at acceptable cost.

Furthermore, in recent years, the use of concentrated aqueous solutions of dyes has gained importance, especially for the dyeing of paper, due to the advantages possessed by such solutions when compared with dyes in powder form. Thus, for example, the use of solutions avoids the difficulties associated with dust formation and releases the user from the time-consuming and frequently difficult dissolving of the dye powder in water. The use of concentrated solutions was also prompted by the development of continuous dyeing processes, since it is convenient in these processes to meter the solution directly into the pulp stream or to add it at some other suitable point during the papermaking process. However, such solutions should be ecologically and toxicologically acceptable, stable on storage, also in concentrated form and be readily pumpable, even at relatively low temperatures.

Thus, a further requisite of such a combination of dyes is that they are capable of being formulated as storage stable, preferably, concentrated, aqueous solutions or suspensions.

However, it would normally be anticipated that a combination of anionic and cationic dyes in aqueous media would lead to precipitation, thus resulting in reduced brilliance and colouristic strength of the dyeings, unstable aqueous liquid formulations and extremely poor affinity of the mixture of dyes to the paper.

Combinations of specific direct dyes and acid dyes, reactive dyes and acid dyes and of acid, direct and reactive dyes have been claimed in US 2003/0116056 A1 and in US 2003/0019393 A1 as mixtures suitable for use in ink jet printing. However, only formulations containing a maximum dye concentration of 5% together with considerable quantities of solvents and other organic additives are actually described.

Mixtures of yellow direct and acid dyes suitable for use in ink jet recording materials have also been disclosed in Japanese Patent Publication No. 11-012514. However, suitable acid dyes are all azo dye derivatives not derived from cationic chromophores.

Surprisingly, however, it has now been found that a suitable combination of appropriate dyes does not suffer from the problems mentioned above, but rather combines the desirable effects of the individual components and, furthermore, may be readily obtained as a storage stable aqueous formulation.

Accordingly, the invention relates to an aqueous formulation comprising
a) 5 to 25%, preferably 8 to 15%, by weight, based on the total weight of the formulation, of at least one anionic dye selected from the group consisting of anionic direct dyes, reactive dyes, inclusive of their hydrolyzed forms and acid dyes providing they do not contain cationic groups or structural units,
b) 1 to 10%, preferably 2 to 6%, by weight, based on the total weight of the formulation, of at least one basic cationic dye and/or acid dye, which is derived from a cationic structural unit in which the cationic charge is compensated or over-compensated by the presence of one or more acid groups, with the proviso that C.I. Acid Red 52, C.I. Acid Red 92 and C.I. Acid Blue 9 are excluded,
c) 0 to 10%, preferably 0 to 1%, by weight, based on the total weight of the formulation, of at least one formulation assistant and
d) water to 100%.

Whilst the anionic dyes, component a) of the formulation, are selected from the group consisting of anionic direct dyes, reactive dyes, inclusive of their hydrolyzed forms and acid dyes, providing the latter do not contain cationic groups or structural units, the anionic direct dyes are most preferred.

Examples of suitable anionic direct dyes are disclosed in the Colour Index under the designation “C.I. Direct”, followed by the colour and the appropriate number.

Such direct dyes may be derived from a wide variety of chemical entities, but contain at least one sulphonic acid group, whereby the number of sulphonic acid groups is varied to obtain optimum affinity, whilst ensuring sufficient water solubility. In addition to sulphonic acid groups, carboxylic acid and phosphonic acid groups may also be present. Most preferred chemical entities arte stilbene derivatives and, especially azo compounds.

Specific examples of dyes suitable for use as component a) of the formulation are C.I. Direct yellows 11, 47, 50, 84, 137, 157 and 160, C.I. Direct Orange 29, C.I. Direct Reds 80, 239 and 254, C.I. Direct Violet 9 and 51 and C.I. Direct Blue 290, although these examples are not intended to be restrictive in nature.

Suitable acid dyes not derived from cationic chromophores are, for example, mono- or bis-azo dyes, substituted with acidic groups and also metal complexes thereof, as are also disclosed in the Colour Index under the designation “C.I. Acid”, followed by the colour and the appropriate number.

With regard to component b) of the formulation, this is a basic cationic dye and/or an acid dye derived from a cationic structural unit, in which the cationic charge is compensated or over-compensated by the presence of one or more acid groups.

Preferably, the basic cationic dye is selected from the group consisting of mono-, bis-, and trisazahemicyanines and may be exemplified by C.I. Basic Red 46, C.I. Basic Blue 3 and 41.

The acid dye is preferably selected from the group consisting of sulphonic acid group containing diphenyl- and triphenylmethanes and xanthenes, such as C.I. Acid Blues 1, 83 and 90, all of which are triphenylmethane cationic dyes in which the cationic charge is over-compensated by the presence of two sulphonic acid groups, which types of dye are especially preferred, thus resulting in an acid dye carrying a net negative charge, although the original chromophore is that of a cationic dye. Further preferred examples are C.I. Acid Violet 17 and 45.

Preferably, the anionic and also the acid dyes are present in the form of readily water-soluble salts. Consequently, suitable salts are alkali metal salts such as lithium potassium or, especially, sodium salts or ammonium salts, mono-, di-, tri- or tetraC₁-C₄alkyl ammonium salts or C₂-C₄hydroxyalkyl ammonium salts or mixtures thereof.

Similarly, in the case of the cationic dyes, the counter ion should be such as to ensure sufficient water solubility. Preferred salts in this case are, for example, halogenides, especially chlorides, sulphates, methosulphates and, in particular lower aliphatic carboxylates such as formates, acetates and lactates.

In case it should be necessary to employ formulating agents, these are selected from those agents normally used to render desirable properties for the application of the formulation. Thus these may be selected from the group consisting consisting of solubilizing agents, hydrotropic agents, viscosity regulators, dispersing agents, microbicides and pH adjusting agents.

The pH of the formulation generally lies within the range of from 5 to 12, but is preferably between 6 and 10.

Furthermore, the dyes used for the preparation of the formulation may contain small quantities of by-products and/or additives resulting from their syntheses, especially mineral salts such as sodium chloride, sodium sulphate, sodium carbonate or the sodium salts of formic, acetic and lactic acids.

The formulation may be simply prepared by mixing the individual components described above in any desired order. Preferably, however, the anionic dye, component a) of the formulation, is first purified, especially by membrane separation techniques such as micro- or ultrafiltration, to remove by-products and reduce salt content. The second dye, component b) of the formulation in the form of a moist filter cake, which may also have been purified, is added to the low salt, concentrated aqueous solution of the anionic dye, component a), followed by addition of the formulating agents, if required. The mixture is then stirred at a temperature of 30-80° C., preferably at 40-60° C., until dissolution is complete. If necessary, the mixture may be subjected to a membrane separation process to remove residual salt. After cooling to 20-30° C. the solution may, if necessary, be clarified.

The formulation of the invention is suitable for dyeing natural or synthetic materials, in particular cellulosic materials in any desirable shade. In particular, the formulations are suitable for dyeing paper and paperboard.

Consequently, in a further aspect, the invention relates to a process for the dyeing of paper, by treating the paper with a liquid composition as defined previously. The liquid preparation is used, optionally after dilution with water, for the dyeing of paper or paperboard, whereby these materials can be dyed, for example, in the pulp, by brushing or immersion or by applying to the paper surface by coating or spraying or for application in a continuous dyeing process, whereby the paper or paperboard which has been dyed with the liquid composition of the invention constitutes a still further aspect of the invention.

The following examples serve to illustrate the invention, without intending to be restrictive in nature. Parts and percentages are by weight unless otherwise stated.

### EXAMPLE 1

To 200 g of an aqueous mixture containing 12% of C.I. Direct Blue 290 (Pergasol ® Blue 2R-Z liquid) there are added 10.6 g of a powder formulation containing 40% of C.I. Basic Blue 41 (Maxilon ® Blue GRL 300% powder) and the mixture stirred for 30 minutes at 60° C. After being allowed to cool over night, the mixture is clarified.

The resulting solution dyes paper in brilliant blue shades, more brilliant than Direct Blue 290 alone, with excellent degrees of exhaustion and fastness to water.

The formulation is stable to storage at temperatures of from −10 to 50° C. over a period of several months.

### EXAMPLE 2

Similarly good results are achieved if, in Example 1, the 10.6 g of Maxilon ® Blue GRL 300% powder are replaced by 5.0 g of Maxilon® Blue 5G-GR 200% (C.I. Basic Blue 3).

### EXAMPLE 3

Similarly good results are achieved if, in Example 1, the 10.6 g of Maxilon ® Blue GRL 300% powder are replaced by 5.0 g of Polar® Blue G-01 300% (C.I. Acid Blue 90).

### EXAMPLE 4

To 200 g of an aqueous mixture containing 13% of C.I. Direct Violet 9 (Pergasol® Violet BN-Z liquid) there are added 8.3 g of a powder formulation containing 40% of C.I. Basic Blue 41 (Maxilon® Blue GRL 300% powder) and the mixture stirred for 30 minutes at 60° C. After being allowed to cool over night, the mixture is clarified.

The resulting solution dyes paper in brilliant blue shades, more brilliant than Direct Violet 9 alone, with excellent degrees of exhaustion and fastness to water.

The formulation is stable to storage at temperatures of from −10 to 50° C. over a period of several months.

### EXAMPLE 5

Similarly good results are achieved if, in Example 4, the 8.3 g of Maxilon® Blue GRL 300% powder are replaced by 5.0 g of Maxilon® Blue 5G-GR 200% (C.I. Basic Blue 3).

### EXAMPLE 6

Similarly good results are achieved if, in Example 4, the 8.3 g of Maxilon® Blue GRL 300% powder are replaced by 2.5 g of C.I. Acid Blue 1.

### EXAMPLE 7

Similarly good results are achieved if, in Example 4, the 8.3 g of Maxilon® Blue GRL 300% powder are replaced by 2.0 g of C.I. Acid Blue 83.

### EXAMPLE 8

Similarly good results are achieved if, in Example 4, the 8.3 g of Maxilon® Blue GRL 300% powder are replaced by 3.0 g of C.I. Acid Blue 90.

### EXAMPLE 9

Similarly good results are achieved if, in Example 4, the 8.3 g of Maxilon® Blue GRL 300% powder are replaced by 5.0 g of C.I. Acid Violet 17.

### EXAMPLE 10

To 350 g of an aqueous mixture containing 12% of C.I. Direct Blue 290 (Pergasol® Blue 2R-Z liquid) there are added 131 g of a liquid formulation containing 13% of C.I. Direct Violet 9 (Pergasol® Violet BN-Z liquid) and 9 g of a moist, low salt filter cake of C.I. Basic Blue 41 (corresponding in strength to 14.8 g of Maxilon® Blue GRL 300% powder) and the mixture stirred for 30 minutes at 60° C. After being allowed to cool over night, the mixture is clarified. The resulting solution dyes paper in brilliant reddish blue shades with excellent degrees of exhaustion and fastness to water.

The formulation is stable to storage at temperatures of from −10 to 50° C. over a period of several months.

### EXAMPLE 11

150 g of a 30% aqueous formulation of C.I. Direct Yellow 11 (Pergasol® Yellow S-Z liquid) are mixed with 4.5 g of C.I. Acid Violet 49, 35 g of a 10.5% aqueous formulation of C.I. Direct Red 239 (Pergasol® Red G liquid), 1.0 g of C.I. Basic Red 46 (Maxilon® Red GRL 200% powder) and 50 g of water at 60° C. and the mixture filtered.

The resulting solution dyes paper in brown shades with an excellent degree of exhaustion giving dyeings with excellent fastness properties.

The formulation is stable to storage at temperatures of from −10 to 50° C. over a period of several months.

### EXAMPLE 12

150 g of a 30% aqueous formulation of C.I. Direct Yellow 11 (Pergasol® Yellow S-Z liquid) are mixed with 5.0 g of C.I. Acid Violet 49, 35 g of a 10.5% aqueous formulation of C.I. Direct Red 239 (Pergasol® Red G liquid) and 20 g of water at 60° C. and the mixture filtered.

The resulting solution dyes paper in brown shades with an excellent degree of exhaustion giving dyeings with excellent fastness properties.

The formulation is stable to storage at temperatures of from −10 to 50° C. over a period of several months.

### EXAMPLE 13

Similarly good results are achieved if, in Example 12, the C.I. Acid Violet 49 is replaced by Polar® Blue G-01 300% (C.I. Acid Blue 90).

1. An aqueous formulation comprising
a) 5 to 25% by weight, based on the total weight of the formulation, of at least one anionic dye selected from the group consisting of anionic direct dyes, reactive dyes, inclusive of their hydrolyzed forms and acid dyes providing they do not contain cationic groups or structural units,
b) 1 to 10% by weight, based on the total weight of the formulation, of at least one basic cationic dye and/or acid dye, which is derived from a cationic structural unit in which the cationic charge is compensated or over-compensated by the presence of one or more acid groups, with the proviso that C.I. Acid Red 52, C.I. Acid Red 92 and C.I. Acid Blue 9 are excluded,
c) 0 to 10% by weight, based on the total weight of the formulation, of at least one formulation assistant and
d) water to 100%.

2. An aqueous formulation, according to claim 1, comprising
a) 8 to 15% by weight, based on the total weight of the formulation, of at least one anionic dye,
b) 2 to 6% by weight, based on the total weight of the formulation, of at least one basic cationic dye and/or acid dye,
c) 0 to 1% by weight, based on the total weight of the formulation, of at least one formulation assistant and
d) water to 100%.

3. An aqueous formulation, according to claim 1, in which the component b) is a basic cationic dye selected from the group consisting of mono-, bis-, and trisazahemicyanines.

4. An aqueous formulation, according to claim 1, in which the acid dye is selected from the group consisting of sulphonic acid group containing diphenyl- and triphenylmethanes and xanthenes.

5. An aqueous formulation according to claim 4, in which the acid dye is a triphenylmethane substituted with two sulphonic acid groups.

6. An aqueous formulation, according to claim 1, in which the formulation assistant is selected from the group consisting of solubilizing agents, hydrotropic agents, viscosity regulators, dispersing agents, microbicides and pH adjusting agents.

7. A process for the preparation of a formulation, according to claim 1, by mixing, in any desired order, a) thru d).

8. A method of dyeing natural or synthetic materials by treating the natural or synthetic materials with the formulation according to claim 1.

9. A method according to claim 8, wherein the materials are paper or paperboard.

10. Paper or paperboard, which has been dyed with a formulation according to claim 1.

11. A method according to claim 8, wherein the natural or synthetic materials are cellulosic materials.
